(19) United States
(12) Patent Application Publication
(10) Pub. No.: US 2024/0273885 A1
(43) Pub. Date: Aug. 15, 2024

(54) ESTIMATION METHOD, APPARATUS AND PROGRAM

(71) Applicant: NIPPON TELEGRAPH AND TELEPHONE CORPORATION, Tokyo (JP)

(72) Inventors: Masahiro YASUDA, Tokyo (JP); Shoichiro SAITO, Tokyo (JP); Yasunori OHISHI, Tokyo (JP)

(73) Assignee: NIPPON TELEGRAPH AND TELEPHONE CORPORATION, Tokyo (JP)

(21) Appl. No.: 18/681,037

(22) PCT Filed: Aug. 6, 2021
(86) PCT No.: PCT/JP2021/029342

§ 371 Date: Feb. 3, 2024

(51) Int. Cl. G06V 10/80; G06V 10/82; G06V 20/40

(52) U.S. Cl. CPC G06V 10/806; G06V 20/44; G06V 10/82

(57) ABSTRACT

An estimation method according to one aspect of the present invention includes: an information acquisition step in which an information acquisition unit 1 is configured to acquire sensor information of a plurality of sensors including at least two types of sensors; a feature value extraction step in which a feature value extraction unit 2 is configured to generate a single feature value from the sensor information of the plurality of sensors; and an estimation step in which an estimation unit 4 is configured to take the single feature value as an input and estimate which of the plurality of sensors is to be focused on using a model utilizing a self-attention mechanism.

### TECHNICAL FIELD

The present invention relates to a technique for estimation using a learning model.

### BACKGROUND ART

A technology for acquiring and understanding human behavior and events that occur in a person's surrounding environment by machines is expected to be applied to systems for supporting human life. Since a single sensor is not sufficient to detect events over a wide area in a real environment, it is necessary to utilize a system that integrates multiple sensors. Furthermore, there may be cases where the image is not visible but audible, or vice versa, so the combination of sensors from multiple modalities is also important.

Multiple sensor integration refers to integration of sensor observations and their characteristics from multiple viewpoints and multiple modalities, and is used for a variety of tasks. Multiple sensor integration includes multimodal integration, which integrates multiple modalities, multi-view integration, which integrates data from multiple viewpoints, and integration of both of these.

In the field of action recognition and detection, feature value integration is mainly employed, where integration is performed at the level of feature values extracted from each of pieces of observed data. Some variations are conceivable for feature value integration according to the problem setting. The simplest feature value integration is sum integration, which adds the feature values extracted from each view.

Another typical form of feature value integration is maximal integration. In contrast to sum integration, which adds all views equally, maximal integration chooses only one valid view for each feature vector element. In 3D object detection tasks, maximal integration achieves higher accuracy than sum integration (see NPL 1).

NPL 2 proposes a more sophisticated multi-view integration by modeling the relationship between sensors in a person action recognition task (see, for example, NPL 2). Multiview integration introduces Conditional Random Fields (CRFs) to model the relationship between views and allows information to be exchanged between views. By considering such relationships between views, multiple views can be linked more effectively.

### CITATION LIST

### Non Patent Literature

[NPL 1] H. Su et al., “Multi-view convolutional neural networks for 3d shape recognition”, ICCV, 2015
[NPL 2] W. Donganget al., “Dividing and Aggregating Network for Multi-view Action Recognition”, ECCV, 2018

### SUMMARY OF INVENTION

### Technical Problem

However, in the integration of distributed sensors with the goal of capturing human behavior in a wide range of real-world environments, the sensors to which attention should be directed may change from time to time. Conventional attention mechanisms represent attention with fixed parameters learned in advance, making it difficult to adapt to such fluctuating conditions.

Therefore, it is an object of the present invention to provide an estimation method, a device, and a program for estimating a sensor to be focused on according to the situation.

### Solution to Problem

An estimation method according to one aspect of the present invention includes: an information acquisition step in which an information acquisition unit is configured to acquire sensor information of a plurality of sensors including at least two types of sensors; a feature value extraction step in which a feature value extraction unit is configured to generate a single feature value from the sensor information of the plurality of sensors; and an estimation step in which an estimation unit is configured to take the single feature value as an input and estimate which of the plurality of sensors is to be focused on using a model utilizing a self-attention mechanism.

### Advantageous Effects of Invention

It is possible to estimate a sensor to be focused on according to a situation.

### BRIEF DESCRIPTION OF DRAWINGS

FIG. 1 is a diagram illustrating an example of a functional configuration of a learning device.

FIG. 2 is a diagram illustrating an example of a processing procedure of a learning method.

FIG. 3 is a diagram illustrating an example of a functional configuration of an estimation device.

FIG. 4 is a diagram illustrating an example of a processing procedure of an estimation method.

FIG. 5 is diagram illustrating an experimental example.

FIG. 6 is diagram illustrating an experimental example.

FIG. 7 is diagram illustrating an experimental example.

FIG. 8 is diagram illustrating an experimental example.

### DESCRIPTION OF EMBODIMENTS

Embodiments of the present invention will be described hereinafter in detail. Further, constituent elements with the same function are denoted by the same reference numerals in the diagrams, and overlapping explanations are omitted accordingly.

### TECHNICAL BACKGROUND

The symbol “˜” used in the following description should be set immediately above the character immediately after correctly, but due to the limitation of the text notation, it is set immediately before the character.

Multi-head attention (MHA) is a mechanism originally proposed in the field of natural language processing (see, for example, Reference 1).

Reference 1: A. Vaswaniet al., “Attention is All you Need”, NIPS, 2017

Attention is a mechanism for deriving a value V from a memory corresponding to a query using the similarity between a key K and a query Q. Attention is formulated, for example, as follows:

$$Attention ( Q , K , V ) = Softmax ( {QK}^{T} / √ {d}_{k} ) V \qquad ( 1 )$$

where dₖ is the number of dimensions of K.

MHA is an extension of this and uses multiple attention heads as follows.

$$Multihead ( Q , K , V ) = Concat ( {head}_{l} , … , {head}_{h} ) {W}_{0} \qquad ( 2 )$$

$$where {head}_{i} = Attention ( {QW}_{i}^{Q} , {KW}_{i}^{K} , {VW}_{i}^{V} ) \qquad ( 3 )$$

When N is a predefined integer greater than or equal to 2, i=1, . . . N, and Xi is an NXi-dimensional vector, then Concat (X1, . . . , XN) combines vectors X1, . . . , XN to produce a Ei=1NNXi-dimensional vector. For example, let 3D vector A be A=(a1, a2, a3) and 3D vector B be B=(b1, b2, b3), then

$$Concat ( A , B ) = ( a 1 , a 2 , a 3 , b 1 , b 2 , b 3 ) .$$

Here, Wo is a model parameter that is a matrix; W^{Q}ᵢ, W^{K}ᵢ, and W^{V}ᵢ are model parameters that are vectors. At a time of training, these model parameters are set to predetermined initial values and are updated by training. At a time of detection, the learned values of these model parameters are used as these model parameters.

h is a predetermined positive integer.

In particular, MHA for the case Q=K=V is called multi-head self-attention (MHSA). In a model called “Transformer”, which has caused breakthroughs in many tasks in natural language processing, MHSA is used to model the relationship between words in a sentence. MHSA excels at modeling internal relations in sequences of various modalities.

Consider the task of event detection using information input from M microphones and N cameras distributed in space. M and N are predetermined positive integers.

The input for this task is a time series of acoustic feature values from M microphones and video feature values from N cameras. This input is denoted as =((1, . . . , VT), As τ∈{1, . . . , T}, ψ_{τ}=(φ1,τ, . . . , φ_{S,τ})^{tr} is the input feature value at time index τ. “tr” in the upper right corner of the vector means transposition. φ_{s,τ}∈R^{D}^{_{S}} is a feature value corresponding to the sensor index s∈{1, . . . , S=M+N} and time index τ. Dₛ is the number of dimensions of the feature value φ_{s,τ} corresponding to the sensor index s, and is a predefined positive integer. It is assumed that all feature values are embedded in a common feature value space of dimension D and that Ds can be simplified to D. That is, D_{S}=D.

As described below, in the embodiment, an information-embedded feature value φ_{s,τ}∈R^{D+S}, exemplified by Equation (3), is used as the feature value Qs, t.

The output of this task is a time series of events activity A=(a₁, a₂, . . . , a_{T}). As τΣ{1, . . . , T}, a_{τ}=(a₁, a_{τ}, . . . , a_{C,τ})^{tr}∈{0, 1}^{C} denotes the event at time index t. C is the number of event classes and is a predefined positive integer. Let G=(g₁, . . . , g_{T}) denote the so-called strong label corresponding to the activity A of the event, which is the correct label.

Instead of such a strong label, the bags label gbag=(g₁^{bag}, . . . , g_{C}^{bag})={0, 1}C may be used as the correct answer label, called the weak label. As CE{1, . . . , C}, g_{c}^{bag} is defined, for example, as follows.

$${g}_{c}^{bag} = \{ \begin{matrix}1 & if ∃ {g}_{c , τ} : {g}_{c , τ} = 1 ; \\ 0 & if ∀ {g}_{c , τ} : {g}_{c , τ} = 0\end{matrix} . \qquad [ Eq . 1 ]$$

That is, g_{c}^{bag}=1 if there exists a g_{c,τ} such that g_{c,τ}=1 among τ∈{1, . . . , T}, g_{c}^{bag}=0 if g_{c,τ}=0 for all τ∈{1, . . . , T}. Here, g_{c,τ} is a value that is 1 if class c is present at time index t and 0 if it is not present.

Successful multi-sensor integration for multi-view cross-modal event detection requires a combination and integration of appropriate sensors that hold sufficient information about the event to be detected.

However, the appropriate sensor to capture an event will vary depending on the situation: when, where, and what kind of event has occurred. For example, in the video modality, it is impossible to observe events hidden by occlusion, and it is difficult to track distant events in detail. In the audio modality, noise and distance attenuation may prevent some sensors from being fully utilized.

Further, which viewpoints and modalities are effective depends on the type of event occurring. For example, a camera showing a person from above is suitable for capturing work with the hands instead of capturing body movements. In order to address such changes in the situation, the inventors has proposed SelfAtt-MSF, a mechanism for sensor integration that directs attention to the appropriate sensor depending on the situation, such as “when, where, and what kind of event has occurred”.

SelfAtt-MSF is implemented as at least one layer of MHSA as follows:

$${ψ}_{τ}^{att} = Multihead ( Multihead ( … ( Multihead ( {ψ}_{τ} , {ψ}_{τ} , {ψ}_{τ} ) ) ) ) \qquad ( 4 )$$

S integrated features corresponding to the number of sensors are obtained as the output of MHSA. That is, ψattτ=(ψatt1, τ, . . . , ψattS,τ). The final integrated features may be obtained by, for example, applying maximum integration or average integration between them, as described below.

In the case where the MHSA is multilayered, the multi-head operation is performed at least two times on the right-hand side of Equation (4). When k is a positive integer greater than or equal to 2, and ψ_{τ}^{k-1} is the result of the k−1th multi-head operation on the right-hand side of Equation (4), then the k-th multi-head operation on the right-hand side of Equation (4) is performed for (ψ_{τ}^{k-1}, ψ_{τ}^{k-1}, ψ_{τ}^{k-1}).

By adopting a modeling based on self-attention, which determines the weight of attention based on the input itself, it can be expected to be able to emphasize and combine appropriate modalities and viewpoints as the situation changes. Furthermore, by employing Multihead, it is expected that multiple heads will be able to work complementary to inputs of different modalities.

Note that since MHSA does not distinguish sensor s in the input feature values, it is necessary to embed information about each sensor from the outside. For this purpose, referring to the position encoding introduced in Transformer (see Reference 3), a sensor encoding expressed as follows is introduced.

$${φ}_{s , τ} = Concat ( \sim {φ}_{s , τ} , {Onehot}_{S} ( s ) ) ∈ {R}^{D + S} \qquad ( 5 )$$

˜φ_{s,τ}∈R^{D} is a vector that is a feature value of the s-th sensor. Onehotₛ(s) is the so-called one-hot vector, which is an S-dimensional vector with the s-th element being 1 and the other elements being 0.

With this operation, each linear layer of SelfAtt-MSF is expected to operate as a sensor-conditioned layer.

### [Learning Device and Method]

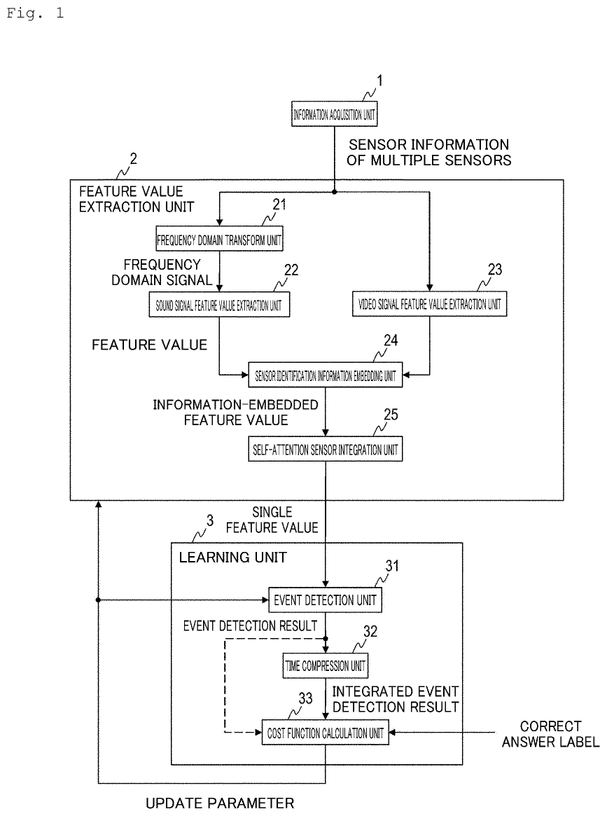

A learning device is provided with, for example, an information acquisition unit 1, a feature value extraction unit 2, and a learning unit 3, as shown in FIG. 1.

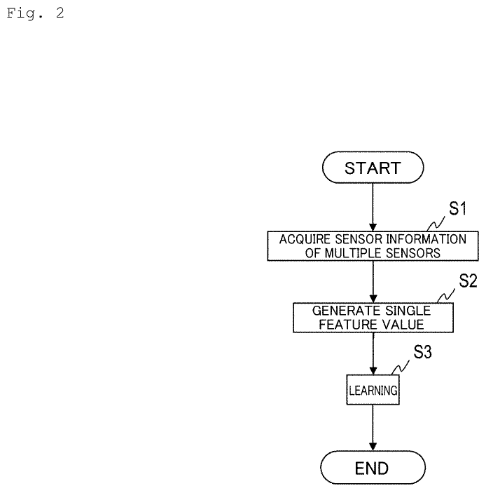

A learning method is realized, for example, by causing each constituent element of the learning apparatus to perform processes from step S1 to step S3 shown in FIG. 2 to be described below.

Each constituent element of the learning apparatus will be described below.

### <Information Acquisition Unit 1>

The information acquisition unit 1 acquires sensor information from a plurality of sensors, including at least two types of sensors (step S1). The acquired sensor information of the plurality of sensors is output to the feature value extraction unit 2.

The information acquisition unit 1 is, for example, a plurality of sensors including at least two types of sensors. The at least two types of sensors are, for example, a microphone 11 and a camera 12. The following is an example of a case where the plurality of sensors are M microphones and N cameras. M and N are predetermined positive integers.

The plurality of sensors are arranged in a distributed manner in a space. The plurality of sensors may be sensors located anywhere in the real space.

Here, “sensor information” refers to the data acquired by the sensor. For example, if the sensor is a microphone, “sensor information” refers to a sound signal acquired by the microphone. Moreover, if the sensor is a camera, “sensor information” refers to a video signal acquired by the camera.

The information acquisition unit 1 acquires the sensor information on the plurality of sensors, for example, from input clips, which are input training data.

### <Feature Value Extraction Unit 2>

The feature value extraction unit 2 generates a single feature value from the sensor information of the plurality of sensors (step S2). The generated single feature value is output to the learning unit 3.

The single feature value can also be called a sensor-integrated feature value.

The following is an example of the processing in the feature value extraction unit 2.

The feature value extraction unit 2 has, for example, a frequency domain transform unit 21, a sound signal feature value extraction unit 22, a video signal feature value extraction unit 23, a sensor identification information embedding unit 24, and a self-attention sensor integration unit 25.

The frequency domain transform unit 21 transforms each of the M input sound signals into M frequency domain signals by a frequency domain transform such as a short-time Fourier transform. The transformed M frequency domain signals are output to the sound signal feature value extraction unit 22.

The frequency domain transform unit 21 generates frequency domain signals, which are log mel spectrograms, by short-time Fourier transform and filter bank processing.

The sound signal feature value extraction unit 22 generates M feature values ˜φ_{s,τ} (s=1, . . . , M) respectively corresponding to the M input frequency domain signals. The generated M feature values ˜φ_{s,τ} (s=1, . . . , M) are output to the sensor identification information embedding unit 24.

The sound signal feature value extraction unit 22 extracts feature values using DNN described in Reference 2, for example. As the model parameters of this DNN, for example, model parameters pre-learned by the technique described in Reference 2 are used. It is assumed that the model parameters of this DNN are common to M frequency domain signals. That is, it is assumed that each of the M frequency domain signals is input to the DNN with the same model parameters.

Reference 2: S. Hershey et al., “CNN Architectures for Large-Scale Audio Classification”, ICASSP, 2017 The video signal feature value extraction unit 23 generates N feature values ˜φ_{s,τ} (s=M+1, . . . , S=M+N) respectively corresponding to the input N video signals. The generated N feature values ˜φ_{s,τ} (s=M+1, . . . , S=M+N) are output to the sensor identification information embedding unit 24.

The video signal feature value extraction unit 23 extracts feature values using DNN described in Reference 3, for example. As the model parameters of this DNN, for example, model parameters pre-learned by the technique described in Reference 3 are used. It is assumed that the model parameters of this DNN are common to N video signals. That is, it is assumed that each of N video signals is input to a pre-trained DNN with the same model parameters.

Reference 3: K. He et al., Deep Residual Learning for Image Recognition”, arXiv: 1512.03385, 2015 Here, with s=1, . . . , S=M+N, the feature value ˜φ_{s,τ}∈R^{D} is a D-dimensional vector feature value corresponding to the time index t corresponding to the sensor s.

The sensor identification information embedding unit 24 embeds sensor identification information corresponding to each of the input M+N feature values ˜φ_{s,τ} (s=1, . . . , S=M+N). Then, the information-embedded feature value φ_{s,τ} corresponding to each sensor is generated. The information-embedded feature values φ_{s,τ} (S=1, . . . , S=M+N) is output to the self-attention sensor integration unit 25.

The sensor identification information embedding unit 24 embeds the sensor identification information according to, for example, Equation (5) to generate the information-embedded feature value φ_{s,τ}. In the example of Equation (5), Onehotₛ(s) is sensor identification information of the sensor s.

The self-attention sensor integration unit 25 integrates multiple information-embedded feature values φ_{s,τ} (s=1, . . . , S=M+N) to generate a single feature value ψ′_{τ}∈R^{D}. The generated single feature value ψ′_{τ} is output to the learning unit 3.

The self-attention sensor integration unit 25 first integrates multiple information-embedded feature values φ_{s,τ} (s=1, . . . , S=M+N) are integrated, thereby generating S integrated feature values ψatt_{τ}=(ψatt_{1,τ}, . . . , ψatt_{S,τ}) corresponding to the number of sensors. In the case where s=1, . . . , M+N, ψ_{atts,τ}∈R^{D} is satisfied.

ψ_{τ} on the right-hand side of Equation (4) is ψτ=(φ_{1,τ}, . . . , φ_{S,τ})^{tr}. Multihead in Equation (4) is defined, for example, by Equations (2) and (3). In the first process of Multihead in Equation (4), ψ_{τ} is input as Q, K, and V in Equations (2) and (3). That is, the operations in Equations (2) and (3) are performed as Q=K=V=ψ_{τ}.

Although the operations are performed as Q=K=V=ψ_{τ}, different model parameters from each other are used for the model parameters W^{Q}ᵢ, W^{K}ᵢ, and W^{V}ᵢ, which are vectors.

The self-attention sensor integration unit 25 then performs a maximum pooling process or average pooling process on the S integrated feature values ψatt_{τ}=(ψatt_{1,τ}, . . . , ψatt^{S,τ}) to generate a single feature value ψ′_{τ}∈R^{D}.

In the case of maximum pooling process, the self-attention sensor integration unit 25 sets the largest vector among D-dimensional vectors ψatt^{1,τ}, . . . , ψatt_{S,τ} that constitute the feature values ψatt_{τ} to ψ′_{τ}.

When ψatt_{s,τ}, which is a D-dimensional vector, is set to ψatt_{s,τ}=(ψatt_{s,τ,1}, . . . , ψatt_{s,τ,D}) to perform average pooling processing, the self-attention sensor integration unit 25 computes ψ′_{τ} where ψ′_{τ}=((1/S)Σₛ₌₁^{S}ψ^{att}_{s,τ,1}, . . . , (1/S)Σₛ₌₁^{S}ψ^{att}_{s,τ,D}).

In this way, the feature value extraction unit 2 extracts the feature values of each sensor based on the sensor information of the plurality of sensors, embeds the identification information of each sensor in the feature value of each sensor, thereby generating the information-embedded feature value corresponding to each sensor, and integrates the multiple information-embedded feature values corresponding to the plurality of sensors respectively, thereby generating a single feature value.

### <Learning Unit 3>

The learning unit 3 updates each model parameter based on the single input feature value and the corresponding correct answer label (step S3).

An example of the process of the learning unit 3 is described below.

The learning unit 3 has, for example, an event detection unit 31, a time compression unit 32, and a cost function calculation unit 33.

The event detection unit 31 performs event detection based on the single input feature value ψ′_{τ}∈R^{D} and generates a C-dimensional vector a_{τ}=(a_{1,τ}, . . . , a_{C,τ})tr representing the event detection result. The event detection result at time index a_{τ}=(a_{1,τ}, . . . , a_{C,τ})^{tr}, which is the event detection result at the time index t, is output to the time compression unit 32.

For example, the event detection unit 31 multiplies the single input feature value ψ′_{τ}∈R^{D} by a linear transformation matrix M₁, which is a model parameter, and performs sigmoid function processing on the multiplication result, thereby generating a C-dimensional vector a_{τ}=(a_{1,τ}, . . . , a_{C,τ})^{tr}. In a case where c∈{1, . . . , C}, 0≤a_{c,τ}≤1.

The time compression unit 32 generates an integrated event detection result a in the time interval from time index 1 to time inde T based on event detection results a1, . . . , a_{T} corresponding to time indices 1, . . . , T, respectively. The integrated event detection result a is output to the cost function calculation unit 33.

The time compression unit 32 generates integrated event detection results by performing operations such as averaging operation, maximum value operation, and weighted averaging operation.

When the averaging operation is performed, the time compression unit 32 calculates the integrated event detection result a, which is, for example, a=((1/T)Σ_{τ=1}^{T}a_{1,τ}, . . . , (1/T)Σ_{τ=1}^{T}a_{C,τ}).

When the maximum value operation is performed, the integrated event detection result a is calculated as a=(max_{τ}a_{1,τ}, . . . , max_{τ}a_{C,τ}).

When the averaging operation is performed, the time compression unit 32 calculates the integrated event detection result a, which is, for example, a=((1/T)Σ_{τ=1}^{T}r_{τ}a^{1,τ}, . . . , (1/T)Σ_{τ-1}^{T}r_{τ}a_{C,τ}).

Here, r_{τ} is a weighting factor, 0≤r_{τ}≤1 and Στ=1^{T}r_{τ=1}.

A weak label, which is a correct label corresponding to the input training data, and the integrated event detection result a generated by the time compression unit 32 are input to the cost function calculation unit 33.

The cost function calculation unit 33 uses the input integrated event detection result a and the input correct answer label (weak label) to calculate the binary cross-entropy loss between them and the model parameters used in the feature value extraction unit 2 and learning unit 3 (in the above example, the model parameters of the sound signal feature value extraction unit 22, model parameters of the video signal feature value extraction unit 23, model parameters of the self-attention sensor integration unit 25, and model parameters of the event detection unit 31) are updated using, for example, gradient descent.

Assuming that there are multiple pairs of training data and correct answer labels corresponding to this training data, the above steps S1 through S3 are performed for each of these multiple pairs. By this processing, each model parameter is updated and the learned model parameter is finally obtained.

The learning may be performed using so-called strong labels (labels that include information on the time of occurrence of events) as the training data. In this case, as shown by the dashed line in FIG. 1, the strong labels as training data and a_{τ}=(a_{1,τ}, . . . , a_{C,t})^{tr}, the event detection result at time index t generated by the event detection unit 31, are output to the cost function calculation unit 33. In this case, the learning device does not need to have the time compression unit 32. The cost function calculation unit 33 uses the input integrated event detection result a_{τ} at the time index t and the input correct answer label (strong label) to calculate the binary cross-entropy loss between them and the model parameters used in the feature value extraction unit 2 and learning unit 3 (in the above example, the model parameters of the sound signal feature value extraction unit 22, model parameters of the video signal feature value extraction unit 23, model parameters of the self-attention sensor integration unit 25, and model parameters of the event detection unit 31) are updated using, for example, gradient descent.

### [Estimation Device and Method]

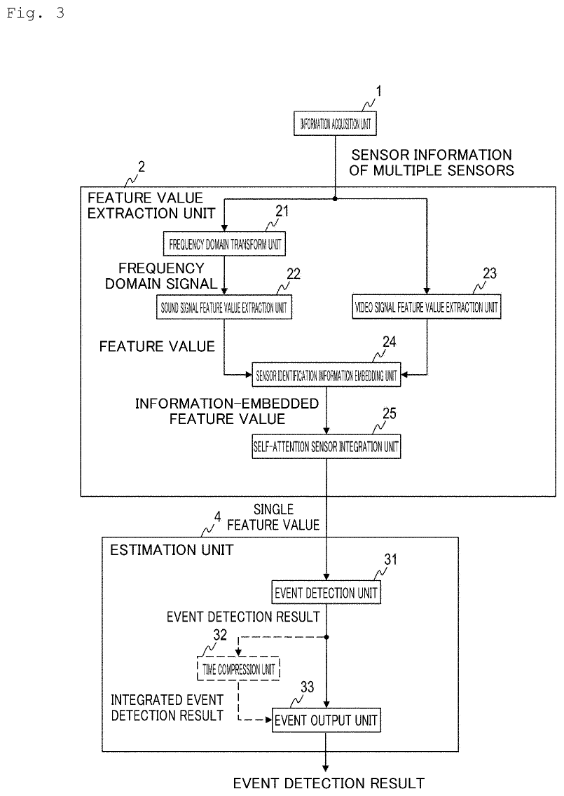

The estimation device has, for example, an information acquisition unit 1, a feature value extraction unit 2, and an estimation unit 4, as shown in FIG. 3.

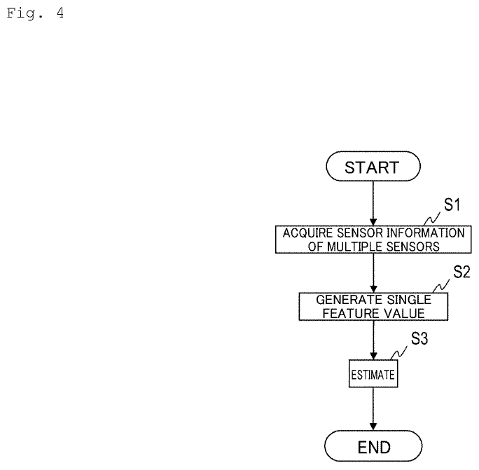

The estimation method is realized, for example, by causing each constituent element of the estimation device to perform processes from step S1 to step S3 shown in FIG. 4 to be described below.

The constituent units of the estimation device will each be described hereinbelow.

The processes of the information acquisition unit 1 and feature value extraction unit 2 of the learning device are performed on input clips that are training data. On the other hand, the processes of the information acquisition unit 1 and feature value extraction unit 2 of the estimation device are performed on the input clips to be estimated.

In the feature value extraction unit 2 of the learning device, model parameters that are set to predetermined initial values and updated by learning are used. On the other hand, the feature value extraction unit 2 of the estimation device uses the model parameters finally learned by the learning device.

Except for these parts, the information acquisition unit 1 and the feature value extraction unit 2 of the estimation device are the same as the information acquisition unit 1 and the feature value extraction unit 2 of the learning device.

Therefore, the estimation unit 4, which is different from the learning device, will be mainly described below.

The single feature value generated by the feature value extraction unit 2 is output to the estimation unit 4.

### <Estimation Unit 4>

The estimation unit 4 takes the input single feature value as an input and estimates which of the plurality of sensors is to be focused on by a model using a self-attention mechanism (step S4). Accordingly, the estimation unit 4 also estimates the events corresponding to the sensor information input to the estimation device (step S4).

An example of the processing in the estimation unit 4 will be described hereinbelow.

The estimation unit 4 has, for example, an event detection unit 31 and an event output unit 41.

In the event detection unit 31 of the learning unit 3 in the learning device, model parameters that are set to predetermined initial values and updated by learning are used. On the other hand, the event detection unit 31 of the estimation unit 4 in the estimation device uses the model parameters finally learned by the learning device.

Except for these parts, the event detection unit 31 of the estimation unit 4 in the estimation device is the same as the event detection unit 31 of the learning unit 3 int the learning device.

Therefore, the event output unit 41, which is different from the learning unit 3 of the learning device, will be mainly described below.

a_{τ}=(a_{1,τ}, . . . , a_{C,t})^{tr}, which is the event detection result at the time index t generated by event detection unit 31, is output to the event output unit 41.

If there is an element larger than a predetermined threshold among the C elements constituting the event detection result aτ at the time index t, which is a C-dimensional vector, the event output unit 41 outputs the event corresponding to the element larger than the predetermined threshold as the event detection result at the time index t.

In this way, by performing model parameter learning and event detection using feature values into which sensor identification information is embedded, it is possible to estimate a sensor to be focused on according to the situation.

Therefore, the final output of the estimation unit 4 is the event detection result; however, in the process of detecting the event, it can be said that which of the plurality of sensors is to be focused on is estimated using a model using a self-attention mechanism.

Note that the estimation unit 4 may include the time compression unit 32, as indicated by the dashed line in FIG. 3.

In this case, a_{τ}=(a_{1,τ}, . . . , a_{C,t})^{tr}, which is the event detection result at the time index t generated by event detection unit 31, is output to the time compression unit 32.

The time compression unit 32 performs processing similar to that of the time compression unit 32 of the learning unit 3 in the learning device to generate the integrated event detection result a. The integrated event detection result a is output to the event output unit 41.

In this case, the event output unit 41 may output the event detection result by performing the same processing as described above on the integrated event detection result a, instead of the event detection result a_{τ} at the time index t.

That is, if there is an element larger than a predetermined threshold among the C elements constituting the integrated event detection result a, which is a C-dimensional vector, the event output unit 41 outputs the event corresponding to the element larger than the predetermined threshold as the event detection result.

Note that the event output unit 41 may detect multiple events.

### Modifications

While embodiments of the present invention have been described above, specific configurations are not limited to the embodiments and, needless to say, the present invention also includes appropriate modifications in design or the like having been made without departing from the spirit and the scope of the present invention.

For example, the at least two types of sensors may be sensors capable of acquiring point cloud, temperature, radio wave intensity, and the like.

The various types of processing described in the embodiments are not limited to being executed in a time series manner in the described order, and may be executed in parallel or individually in accordance with the processing capability of the device that executes the processing or as required.

Data may be directly exchanged between the constituent elements of the estimation device or may be exchanged via a storage unit (not illustrated).

### [Program, Recording Medium]

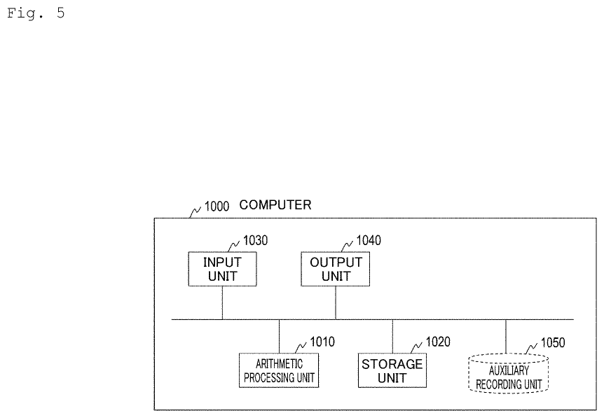

The processing of each unit of each device may be implemented by a computer, and in this case, the processing details of the functions that each device should have are described by a program. The various types of processing functions of each device are implemented on a computer, by causing this program to be loaded onto a storage unit 1020 of the computer 1000, and operating an arithmetic processing unit 1010, an input unit 1030, an output unit 1040, and the like shown in FIG. 5.

A program describing this processing content can be recorded on a computer-readable recording medium. The computer-readable recording medium is, for example, a non-transitory recording medium, and specifically a magnetic recording device, an optical disc, and the like.

The program is distributed, for example, by sales, transfer, or lending of a portable recording medium such as a DVD or a CD-ROM on which the program is recorded. In addition, the distribution of the program may be performed by storing the program in advance in a storage device of a server computer and transferring the program from the server computer to another computer via a network.

The computer executing such a program first temporarily stores the program recorded in the portable recording medium or the program transferred from the server computer, for example, in an auxiliary recording unit 1050, which is its own non-transitory storage device. Then, when executing processing, the computer reads the program stored in the auxiliary recording unit 1050 serving as its own non-transitory storage device onto the storage unit 1020, and executes processing according to the read program. Alternatively, as another of executing the program, the computer may read the program directly from the portable recording medium onto the storage unit 1020, and execute processing according to the program, or the computer may sequentially execute processing according to the program received from the server computer every time the program is transferred thereto from the server computer. Furthermore, instead of transferring the program to the computer from a server computer, the processing described above may be executed by a so-called ASP (Application Service Provider) type service, in which a processing function is realized by execution commands and result acquisition alone. Note that the program in this embodiment includes information to be used for processing by a computer and equivalent to the program (data which is not a direct command to the computer but has a property that regulates the processing of the computer and the like).

In addition, although the present device is configured by executing a predetermined program on the computer in this from, at least a part of the processing content may be implemented by hardware.

In addition, changes, alterations or modifications can be made as appropriate without departing from the gist of the present invention.

### Experimental Example

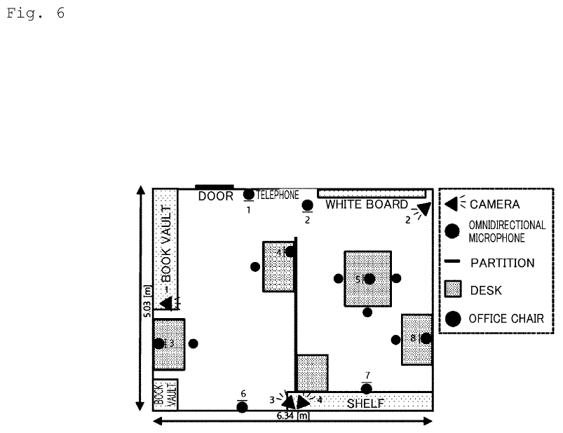

Experiments were conducted using the Multi-view Multi-modal Office Dataset (MM-Office), which records the behavior of people in an environment simulating an office room as shown in FIG. 6 from multiple perspectives and multiple modals. The experimental results are shown below.

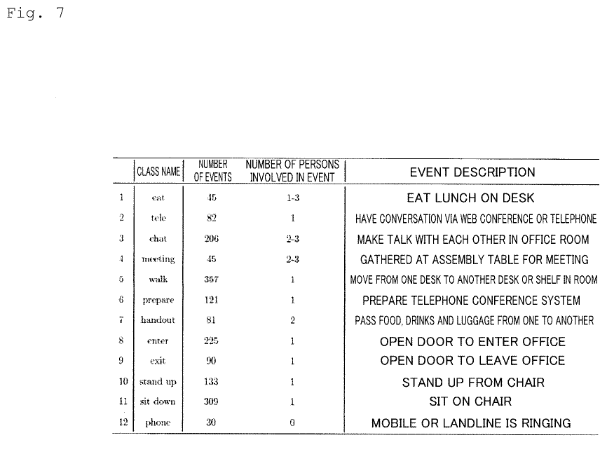

This data set contains 12 events assuming actions in the office shown in FIG. 7. These actions are recorded simultaneously using eight omnidirectional microphones and four cameras. Audio and video clips are divided into scenes, each of which is about 1 to 3 minutes long. The amount of data is a total of 440 clips per point/sensor, of which 352 clips were used for learning and 88 clips were used for evaluation.

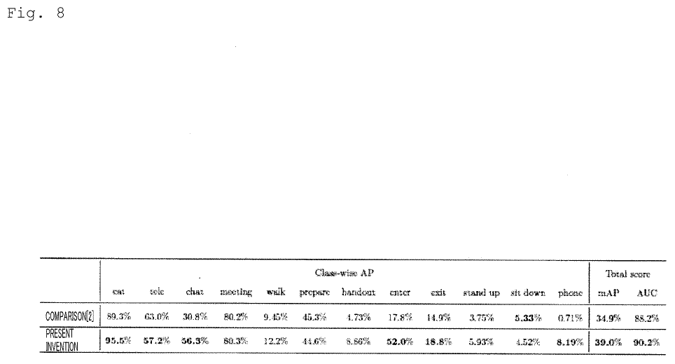

FIG. 8 shows the event detection performance of the technique of the embodiment of the invention and the comparison technique. It can be seen from FIG. 8 that the event detection performance of the technique according to the embodiment of the present invention outperforms the CRF-based conventional technique.

1. An estimation method comprising:
acquiring acquire sensor information of a plurality of sensors including at least two types of sensors;
extracting generate a single feature value from the sensor information of the plurality of sensors; and
the single feature value as an input and estimate which of the plurality of sensors is to be focused on using a model utilizing a self-attention mechanism.

2. The estimation method according to claim 1, wherein extracting a feature value of each sensor based on the sensor information of the plurality of sensors, embedding identification information of each sensor in the feature value of each sensor to generate an information-embedded feature value corresponding to each sensor, and integrating a plurality of information-embedded feature values corresponding to the plurality of sensors respectively to generate the single feature value.

3. The estimation method according to claim 1, wherein estimating an event corresponding to the sensor information.

4. An estimation device comprising:
processing circuitry configured to
obtain acquire sensor information of a plurality of sensors including at least two types of sensors;
generate a single feature value from the sensor information of the plurality of sensors; and
estimate the single feature value as an input and estimate which of the plurality of sensors is to be focused on using a model utilizing a self-attention mechanism.

5. (canceled)

6. The estimation device according to claim 4, further comprising
processing circuitry configured to
extract a feature value of each sensor based on the sensor information of the plurality of sensors, embedding identification information of each sensor in the feature value of each sensor to generate an information-embedded feature value corresponding to each sensor, and integrating a plurality of information-embedded feature values corresponding to the plurality of sensors respectively to generate the single feature value.

7. The estimation device according to claim 4, further comprising
processing circuitry configured to
estimate an event corresponding to the sensor information.

8. A computer readable medium storing instructions that when executed cause a processor to perform operations, comprising:
acquiring acquire sensor information of a plurality of sensors including at least two types of sensors;
extracting generate a single feature value from the sensor information of the plurality of sensors; and
estimating by taking the single feature value as an input and estimate which of the plurality of sensors is to be focused on using a model utilizing a self-attention mechanism.

9. The method according to claim 8 further comprising:
extracting a feature value of each sensor based on the sensor information of the plurality of sensors, embedding identification information of each sensor in the feature value of each sensor to generate an information-embedded feature value corresponding to each sensor, and integrating a plurality of information-embedded feature values corresponding to the plurality of sensors respectively to generate the single feature value.

10. The method according to claim 8, further comprising:
estimating an event corresponding to the sensor information.
